(19) United States
(12) Patent Application Publication
(10) Pub. No.: US 2009/0026863 A1
(43) Pub. Date: Jan. 29, 2009

(54) Magnetic unit power plant system (MUPPS)

(76) Inventors: Joseph E. Spallone, Lebanon, PA (US); Mary A. Spallone, Lebanon, PA (US)

Correspondence Address: JOSEPH E. SPALLONE, 20 BERBEC AVENUE, LEBANON, PA, 17042-7106, US

(21) Appl. No.: 11/983,155

(22) Filed: Jun. 13, 2008

Related U.S. Application Data
(60) Provisional application No. 60/932,918, filed on Jun. 4, 2007.

(51) Int. Cl. H02K 23/04; H02N 11/00

(52) U.S. Cl. 310/152; 415/916

(57) ABSTRACT

The “MUPPS” Magnetic Unit Power System, employes a source of energy that has existed for eons, yet only with the assembly of items illustrated in parts specifications, “MUPPS” allows natural elements to accomplish many desired and needed remedies . . . Clean Power, No Dioxide into atmosphere, No Hazards to Environment, also at No time will so many be held captive by so few!Once again we say, Simplicity at its finest!

### PARTS SPECIFICATION

| MAGNETS | SHUTTLE | HOUSING | LOCK DEVICE | CORE & PANEL |
|---|---|---|---|---|
| Alnico 5 | AL5 | Plastic | Plastic or | Stiff |
| Rods | Rod | Tubing or | Anti Mag | Aluminum |
| .875D × 2.OL | 375D × | Anti Mag | Material | to MUPP |
| or greater | 2.OL | To MUPP | To MUPP | Size |
| To Mupp | Size Needs | Size Needs | Size Needs | Needs |

Coils

Equally wound wiring, some units in parallel, some single wound. Be advised size of wiring in thickness will vary, depending on need.

Power Resisters or Capacitors

Size varies to meet project needs.

Pony Spyder Drive

Plastic or Anti Mag material, size depends on need of project. Magnet(s) size determined by need of project.

Relays for power to existing alternator on vehicle to get MUPP, See power resister or capacitor, sized to neet needs.

Relay For Power Storage to existing battery on vehicle to get MUPP.

Gear Box Housing

Aluminum sized to need.

Gear

Aluminum, helicopter type, sized as needed for project, to control motion engagement, Forward or Reverse of Vehicle, or item being energized by MUPP. This is independent of already installed Forward or Reverse by unit being used Manufacturer.

There are two circular self contained units to our energy provider, utilizing all parts as shown in parts specification that are housed independently in MUPP, consisting of size to be determined by need, circular heavy gauge plastic or aluminum or ceramic, of non-magnetic composition, that is approved to house magnetic shuttle system, consisting of a series of magnets, evenly spaced within above described enclosures, spaced after being calculated to be sure there will not be a magnet coming to rest in a coil chamber when in the stop position.

In the initial start of MUPP, magnets are moved along side existing band of encased magnets, rotating around such band until engagement of power thrust is effected and at time, that start unit disengages, returning to the rest position until activated once again for start procedure, known as Pony Spyder Drive System.

The housing tube will be held in a fixed position by a strap having a curved holder at each end, allowing housing tube to be held firmly as circulating action is being exercised, with a permanent attachment to second unit known as Spyder Drive System.

Once unit is in motion of magnets circling through coils with power being built up for storage and propulsion when engaged for movement, a relay will direct power for storage to be stored to fill capacity, with a cut off to preclude possible over storage with directed flow to existing unit battery for continious flow of energy of unit to be powered, ie car, ship, aircraft or any other mechanical device having need of MUPP System.

Size of MUPP System is to be determined on need for use of MUPP . . . remember! any change of weight in using MUPP, must be compensated for, such as replacement of auto engine weight when replaced with MUPP, should user so elect.

The limited gear system to be used with MUPP, will be the type system used in rotor engagement of 60 or 45 or 90 degree angle engagement, with stress factors calculated for strain and part of system life span.

All MUPP system parts are total unit replacement designed recommended, except in dire emergency circumstances to allow movement to nearest MUPP replacement center.

All Military units employing MUPP System for given piece of equipment, should have at least one replacement unit, with manual/tooling for replacement installation.

Any civilian replacement MUPP System can be acquired by owner of MUPP unit designed for and owned by that person with manual/tooling for replacement installation.

1. The use of this new natural source of energy in the “MUPPS” Magnetic Unit Power Plant System, will serve multiple cost savings in type fuel being used at present time, with possible environment, atmospheric clearing over a reasonable period of time, that will revolutionize use of natural products in the creation of energy . . . Simplicity at its finest!
